(19) United States
(12) Patent Application Publication
(10) Pub. No.: US 2021/0153984 A1
(43) Pub. Date: May 27, 2021

(54) Dental Impression Tray

(71) Applicant: Solving Digital Dental Inc.,, Paris (CA)

(72) Inventor: Jonathan Mahn, Paris (CA)

(73) Assignee: Solving Digital Dental Inc.,, Paris (CA)

(21) Appl. No.: 17/098,718

(22) Filed: Nov. 16, 2020

Related U.S. Application Data
(60) Provisional application No. 62/941,000, filed on Nov. 27, 2019.

(51) Int. Cl. A61C 9/00

(52) U.S. Cl. CPC A61C 9/0006

(57) ABSTRACT

A dental impression tray includes; a U shaped base, which includes a U shaped planar impression table, an outer wall and an inner wall, wherein the impression table extends between the inner wall along an inner periphery and the outer wall along an outer periphery, wherein the inner and outer walls extend upwardly from the base. The impression table together with the inner and outer walls thereby define a U shaped bite channel configured for receiving therein impression material and a set of teeth, thereby operably taking impressions of the teeth. The impression table includes numerous planar knock-out panels arranged in side by side fashion along the center line, the knock-out panels are configured to be selectively removed from the impression table thereby selectively providing an opening through the impression table. Each knock out panel is separated from the adjacent knock out panel by a panel gap at an open side wherein the gap extends transversely to the center line and between the inner and outer wall.

This application claims priority from U.S. provisional application No. 62/941,000 filed Nov. 27, 2019 under the title “A Dental Impression Tray” by inventor Jonathan Mahn.

### FIELD OF THE INVENTION

The present concept relates generally to dental impression trays and more particularly relates to dental impression trays for dental implants.

### BACKGROUND OF THE INVENTION

Dental impression trays are used to hold dental impression material which is then placed into the jaw or mouth of the patient in order that an impression of the teeth and or the voids that are present within the upper or lower set of teeth can be reproduced in the form of a negative impression. Normally the impression material is placed in the tray before it is placed either into the upper or lower jaw over top of the teeth and gums. The dental impression trays are normally shaped and or fitted over the teeth and gums in a jaw to fit over the teeth and gums in a comfortable manner. It is often necessary to have a number of different sizes of dental impression trays in order to accommodate the various jaw sizes that typically exist in a population of people.

When placing dental implants there is the further complication that when making the impression a coping or positioning post is generally placed into the dental implant in order to delineate the location of the implant relative to the neighbouring teeth and relative to the jaw itself. This coping is normally a positioning post of metal material such as titanium which normally projects higher than the surrounding teeth and provides a location reference point to reference the location of the attachment to the dental implant relative to the neighbouring teeth, gums, and jawbone.

Because of the length of the protruding coping during a dental impression procedure the coping will project through the bottom of the base of the dental impression tray and this requires the dentist to cut a hole into the dental impression tray with a dental burr or drill or otherwise somehow create an opening in the dental tray to allow for the coping to project through the bottom of the base of the impression tray.

There are a number of dental impression trays which have been patented, however which do not address the present issue, namely the projection of the coping through the bottom of the base of the dental impression tray for taking impressions which are used for placement for dental implants. To the inventor's knowledge there's only one commercially viable tray which is currently on the market which uses a cellophane or frangible thin plastic liner in the tray bottom which can easily be pierced open by the coping which is in place during the taking of an impression.

The inventors also aware of U.S. Pat. No. 6,428,315 titled ‘Dental Impression Tray’ invented by David Michael Prestipino which was filed on Jun. 29, 2000 under application Ser. No. 09/606,192 and issued on Aug. 6, 2002. This tray describes a structure which allows one to detach entire portions of the tray and/or to remove panels located in the base of the tray by breaking frangible portions and connecting strips as described in the patent. The difficulty with this dental impression tray is the possibility of inadvertent detachment of sections during the taking of an impression. Another difficulty with this design is the large size of the removable panels which will result in reduction in the structural rigidity of the impression tray causing inaccurate impressions to be taken. Furthermore, once the sections are removed a large number of sharp edges are exposed which could easily cut or damage the gums of the patient thereby making this tray somewhat difficult to use without harming the patient. Lastly in order to remove a panel which is denoted as numeral 26 in FIG. 2 for example, it is necessary first of all to break side creases which are denoted as number 25 in FIG. 2 and in addition it is necessary to break the connecting strips which are denoted as numerals 32 also in FIG. 2. In order to remove a panel, it is required that some kind of a burr, drill or cutting device be used in order to sever the connecting strips 32. Additionally, by breaking the side creases 25, one is introducing very sharp edges into the mouth of the patient which again tend to create a safety issue, namely the real potential of cutting into the gums of the patient.

A dental impression tray is required for the use of taking impressions for the placement of dental implants that allows for the projection of the coping through the bottom of the base of the dental impression tray through small windows which can be easily opened by the user dentist with minimal effort and use of standardized tools which are available to the dentist in their office.

### SUMMARY OF THE INVENTION

A dental impression tray includes a U shaped base 102, defining an impression table 105 extending between an inner periphery 104 and an outer periphery 106; an outer wall 108 extending upwardly from the outer periphery 106 of base 102; an inner wall 110 extending upwardly from the inner periphery 104 of base 102; a handle 112 connected to the base 102 at a handle end 114; wherein the base 102, the outer wall 108 and the inner wall 110 are dimensioned and configured to be placed around a jaw; the impression table 105 includes numerous knock-out panels 120 which can be selectively removed from the impression table 105 thereby providing an opening 122 through the impression table 105.

The dental impression tray is configured to receive impression material and a set of teeth thereon for operably taking impressions of the teeth. The impression tray includes a U shaped base which includes a planar impression table connected to upwardly projecting outer and inner walls, the outer wall extending along an outer periphery, and an inner wall extending along an inner periphery.

A the impression table together with the inner and outer walls together define a bite channel.

The impression table includes numerous planar knock-out panels arranged in side by side fashion along a center line of the impression table, the knock-out panels include frangible portions such that the knock out panels are configured to be selectively removable from the impression table thereby selectively providing an opening through the impression table

### BRIEF DESCRIPTION OF THE DRAWINGS

With the intention of providing demonstration of characteristics of the device or method, an example or examples are given below without restrictive character whatsoever with reverence to the corresponding figures of preferred embodiments of the device and method as follows:

FIG. 1 is a schematic top isometric view of a lower impression tray.

FIG. 2 is a schematic top plan view of the lower impression tray shown in FIG. 1.

FIG. 3 is a schematic side plan view of the lower impression tray shown in FIG. 1.

FIG. 4 is a schematic end plan view of the impression tray shown in FIG. 1.

FIG. 5 is a schematic top isometric view of the impression tray as shown in FIG. 1 with one of the knockout panels partially removed using a knockout pointer which in practice can be the handle of the dental mirror.

FIG. 6 is a schematic top isometric view of an upper impression tray.

FIG. 7 is a schematic top plan view of the upper impression tray shown in FIG. 6.

FIG. 8 is a schematic side plan view of the upper impression tray shown in FIG. 6.

FIG. 9 is a schematic end plan view of the impression tray shown in FIG. 6.

FIG. 10 is a schematic top isometric view of the impression tray as shown in FIG. 6 with one of the knockout panels partially removed using a knockout pointer which in practice can be the handle of the dental mirror.

### DETAILED DESCRIPTION OF THE PREFERRED EMBODIMENTS

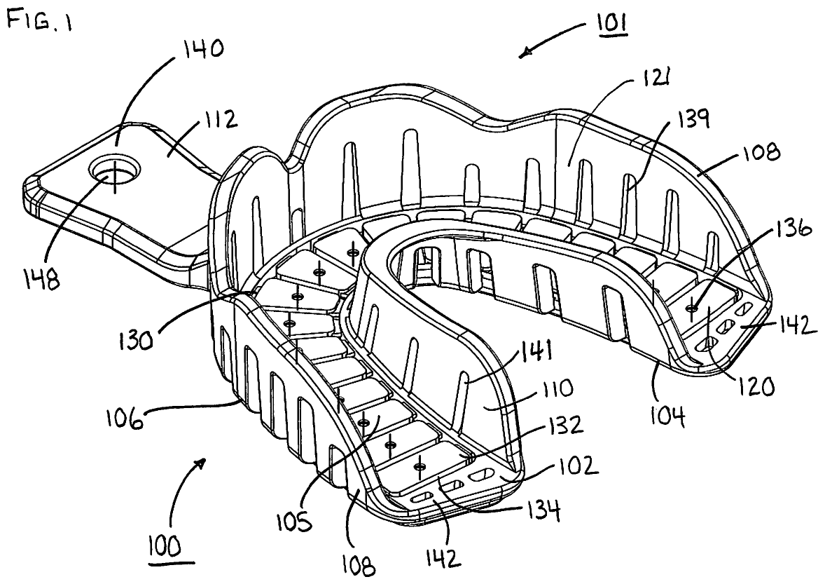

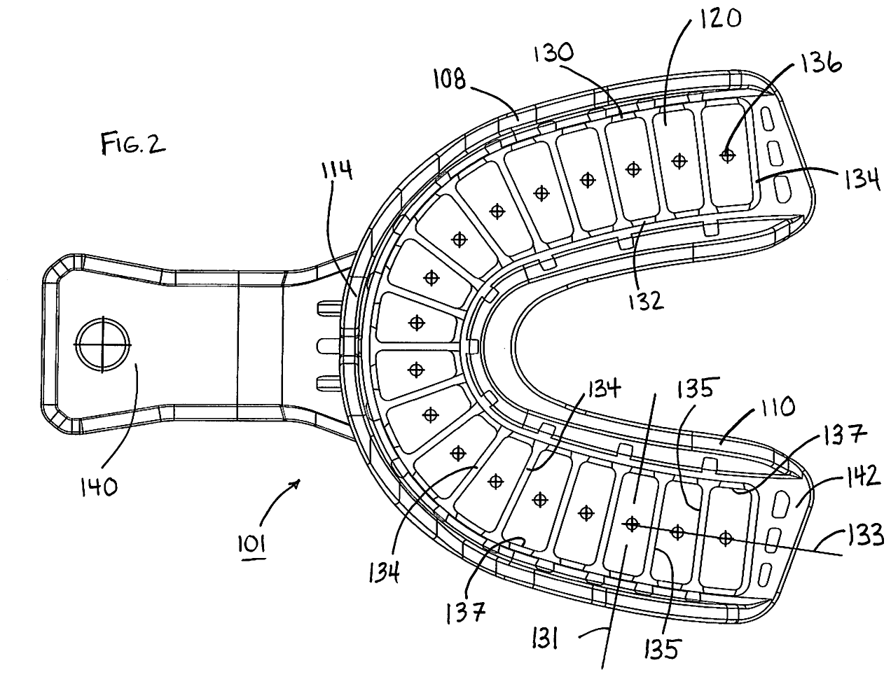

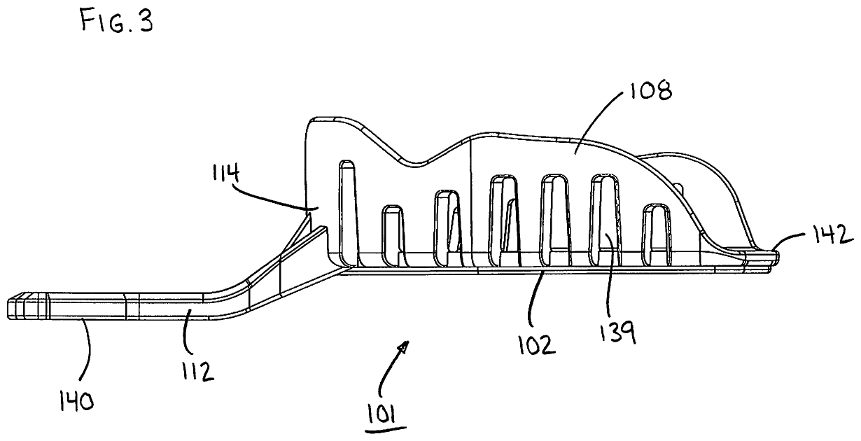

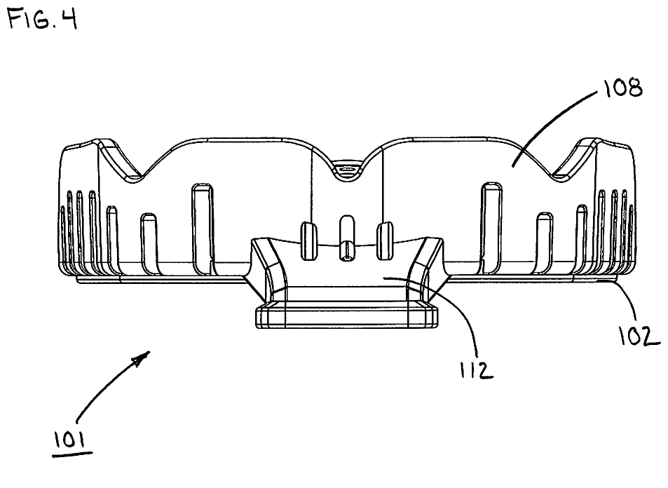

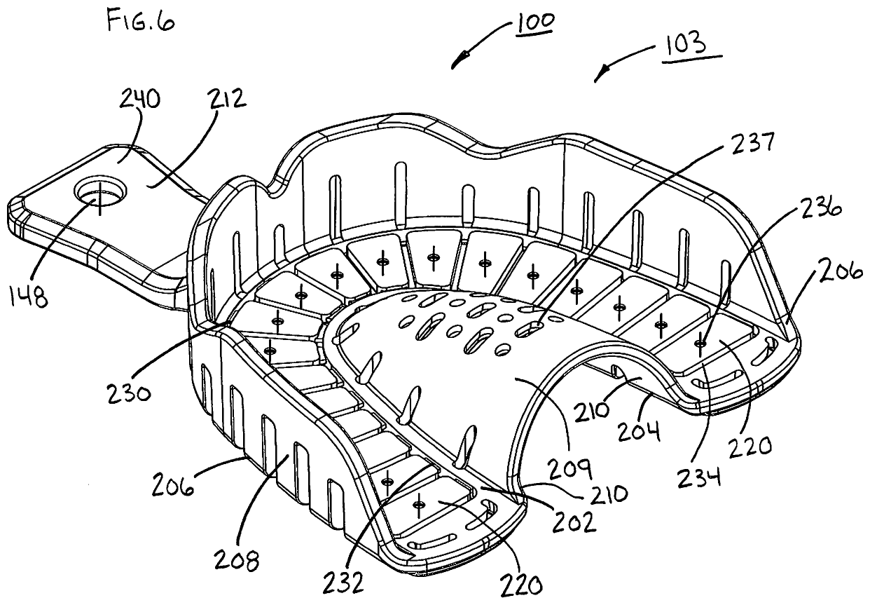

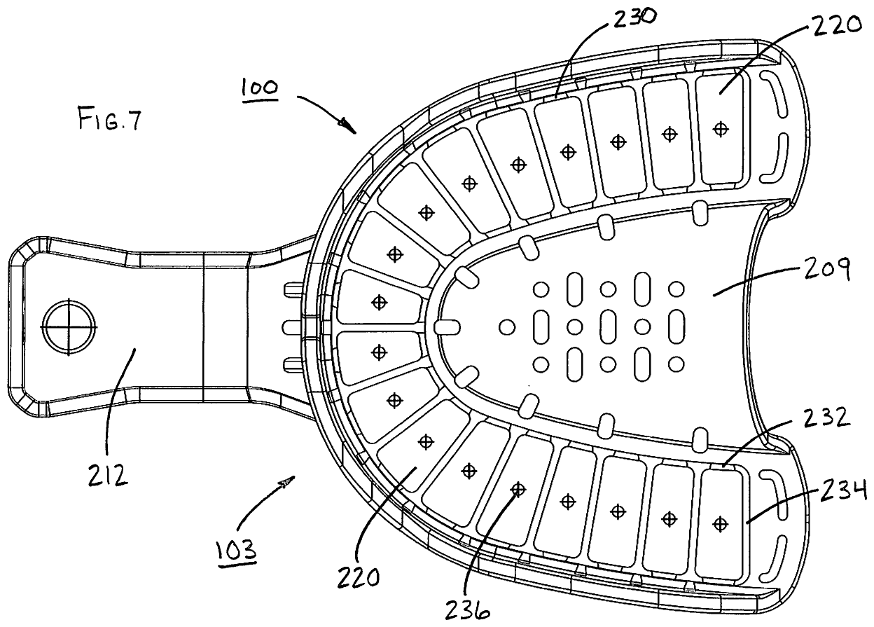

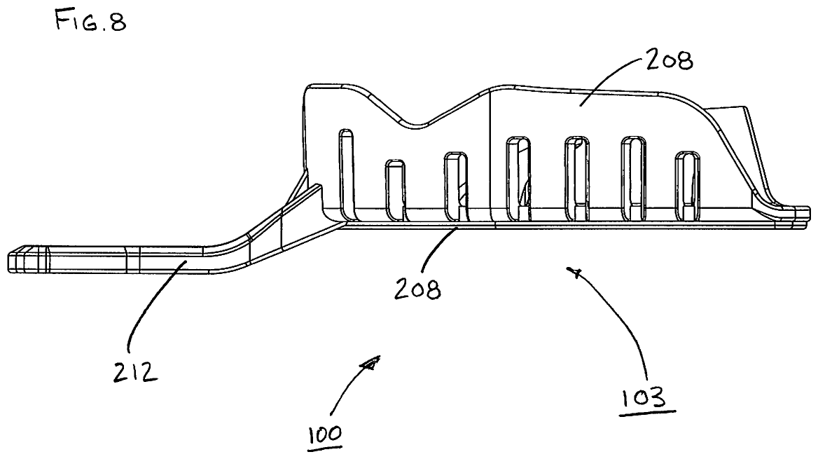

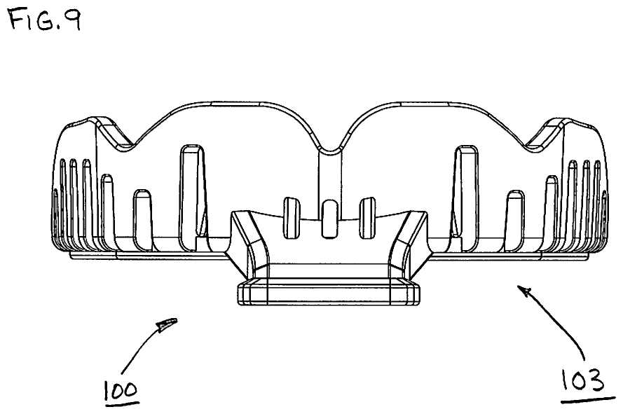

The present concept A Dental Impression Tray is shown in FIGS. 1 through 10 and more particularly a lower impression tray 101 is shown in FIGS. 1 through 5 and an upper impression tray 103 is shown in FIGS. 6 through 10. The lower impression tray 101 is generally used for taking impressions of the lower jaw whereas the upper impression tray 103 is generally used for taking impressions of the upper jaw. Lower impression tray 101 and upper impression tray 103 are substantially the same except for modifications to the inner wall 210 which includes the addition of a palate guard 209.

Dental impression tray 100 includes a U shaped base 102, which includes a planar impression table 105, an outer wall 108 and an inner wall 110, wherein the impression table 105 extends between the inner wall 110 along an inner periphery 104 and the outer wall 108 along an outer periphery 106, wherein the inner 110 and outer 108 walls extend upwardly from the base 102.

Impression table 105 together with the inner 110 and outer 108 walls define a U shaped bite channel 121 configured for receiving therein impression material and a set of teeth which may be for example a set of upper maxillary teeth or a set of lower mandibular teeth therein thereby operably taking impressions of the teeth.

U shaped bite channel 121 is configured to receive a set of lower teeth also called mandibular teeth and a set of upper teeth also called maxillary teeth. U shaped bite channel 121 is taken from known human bite patterns for both the lower and upper bite palates. The impression tray 100 may be produced in various sizes to accommodate children and adults of various sizes. The shape and size of the bite channel 121 is taken from known publicly available data.

Impression table 105 includes numerous planar knock-out panels 120 arranged in side by side fashion along the center line 133. Center line 133 is taken through the center of guide holes 136 and follows centrally along bite channel 121. The knock-out panels are configured to be selectively removed from the impression table 105 thereby selectively providing an opening 122 through the impression table 105. The opening 122 is very desirable for receiving there through a positioning post particularly when taking impressions for the installation of implants. It is possible to remove any number of knock-out panels 120 desired.

Each knock out panel 120 is separated from the adjacent knock out panel 120 by a panel gap 134 at an open side 135 wherein the gap 134 extends transversely relative to the center line 133 and between the inner 110 and outer 108 wall. The transverse center line 131 extends perpendicular to center line 133 and defines a transverse direction relative to center line 133.

Each knock out panel is connected to the base 102 at a tab end 137, one end adjacent the inner wall 110 with an inner frangible tab 132 and the other end adjacent the outer wall 108 with an outer frangible tab 130.

Each knock out panel includes a guide hole aligned along center line 133 which acts as a locatable landing for receiving an instrument for applying force to the knockout panel 120 to break the inner and outer frangible tabs.

Each knock out panel includes a guide hole aligned along the center line which acts as a locatable landing for receiving the end 125 of a knock out pointer 124 thereon for applying force to break the inner and outer frangible tabs. The knock out pointer 124 may be the end of a dental mirror handle or a specialized tool.

Each knock out panel includes a guide hole proximate the center line configured for receiving a rigid rod there through for twisting the knock out panel about a transverse center line 131 thereby breaking the inner and outer frangible tabs leaving an opening in impression table 105. The rigid rod may be the end of a dental mirror or a specialized tool.

Impression table 105 includes an end cross brace 142 at each distal end of planar impression table 105 to improve stiffness of the dental impression tray 100.

The inner wall 110 may also take the shape of a continuous arch shaped palate guard 209 such that the impression tray is adapted to be more comfortable and suitable for taking impressions of upper maxillary teeth.

Outer wall 108 includes outer slits 139 for receiving there through excess impression material upon taking an impression.

Inner wall 110 includes inner slits 141 for receiving there through excess impression material upon taking an impression.

Impression tray 100 further includes a handle 112 connected to the base 102 at a handle end 114, the handle for hand gripping and manipulating the dental impression tray.

I will now describe the lower impression tray 101 which is shown in FIGS. 1 through 5 and then I will briefly describe the upper impression tray 103 which the reader will note that for all intensive purposes is almost identical except for a few unique features to the upper impression tray 103 as compared to the lower impression tray 101.

Lower impression tray 101 and upper impression tray 103 are substantially the same except for modifications to the inner wall 210 which includes the addition of a palate guard 209. The shape of Inner walls 210 is configured to form a palate guard 209 which may be preferred when taking impressions of the upper set of teeth. The technology employed with the lower impression tray 101 is the same as the technology that is being employed onto the upper impression tray 103.

The following are the major components of lower impression tray 101 namely base 102 inner periphery 104 having an inner wall 110 extending therefrom, an outer periphery 106 having an outer wall 108 extending therefrom.

Base 102 defines an impression table 105 upon which impression material is normally applied before inserting the impression tray into the lower jaw of the patient.

Impression table 105 is made up of numerals knockout panels 120 which are held in place by outer frangible tabs 130 and inner frangible tabs 132.

Surrounding knockout panels 120 are also panel gaps 134 which essentially are voids all around knockout panels 120 except where the inner and outer frangible tabs 132 and 130 are located.

Knockout panels 120 further include guide holes 136 indicating to the user where pressure should be applied in order to knockout a knockout panel 120. The guide hole 136 is also adapted for receiving a thin rod therethrough (not shown) such as the end of a dental mirror for urging or twisting a knock out panel 120 about a transverse axis thereby breaking the inner 132 and outer 130 frangible tabs for removing a knock out panel 120 from the impression tray 101.

Inner wall 110 includes inner slits 141 which are essentially opening in the inner wall 110 to allow for excess impression material to seep through. Likewise, outer wall 108 includes outer slits 139 which again are openings which allow excess impression material to seep through.

Lower impression tray 101 further includes a handle 112 having a grip portion 140 and a grip aperture 148. Lower impression tray 101 further includes a stiffening cross braces 142 in order to maintain the stiffness of lower impression tray 101 despite removal of knockout panels 120 from the base 102 of impression tray 101.

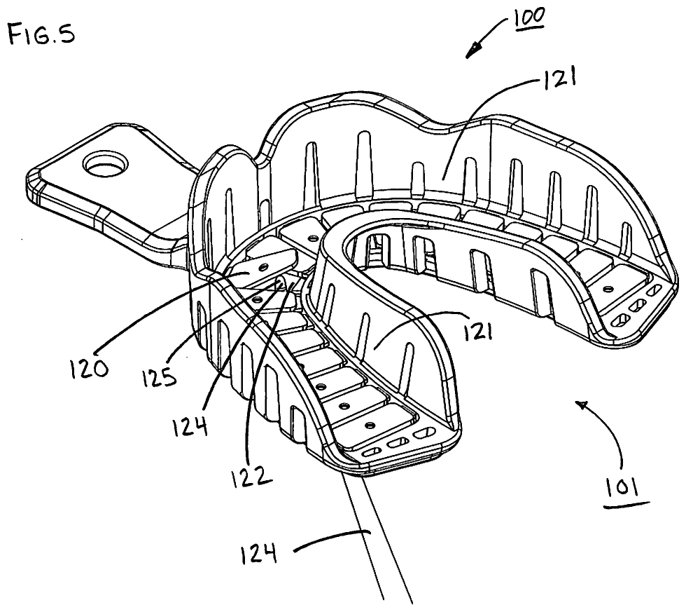

Referring now to FIG. 5 which shows schematically an end 125 of a knockout pointer 124 projecting through the void left by a partially removed knockout panel 120 as shown in FIG. 5.

The end 125 is preferably placed onto the guide hole 136 and pressure applied to the knockout panel 120 such that inner frangible tabs 132 and outer frangible tab 130 are severed thereby releasing and removing knockout panel 120 from the lower impression tray 101. The guide hole 136 may be adapted in size to just receive there through a rod shaped end 125 of knock out pointer 124 or the end of dental mirror (not shown) for twisting knock out panel 120 about transverse center line 131 thereby breaking inner 132 and outer 130 frangible tabs.

Referring now to FIG. 6 through 10, the structural features of the upper impression tray 103 is very similar to lower impression tray 101 except for the fact that upper impression tray 103 includes a palate guard 209 instead of inner walls 110 and inner slits 141. Otherwise upper impression tray 103 is almost identical to lower impression tray 101 and upper impression tray 103 includes a base 202, an outer periphery 206, an inner periphery 204, an outer wall 208, a palate guard 209 rather than inner wall 110 wherein the palate guard 209 includes palate openings 237.

Upper impression tray 103 further includes knockout panels 220 which have their round panel gaps 234 and are held in position with inner frangible tabs 232 and outer frangible tabs 230 in similar fashion as lower impression tray 101. Knockout panels 220 further include guide holes 236 and upper impression tray 103 also includes handle 212 which has a grip portion 240 and a grip aperture 148.

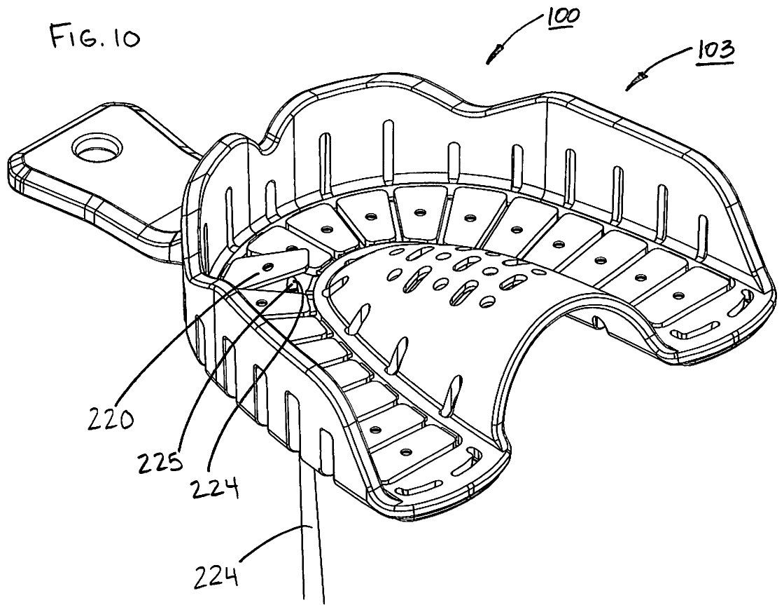

Shown in FIG. 10 is an end 225 of a knockout pointer 224 knocking out one of the knockout panels 220.

In practice knockout pointer 224 and knockout panel 124 could easily be the handle end of a dentist mirror and/or the handle end of any instrument which is found in a dental office.

Referring now to FIGS. 1 through 5 once again, lower impression tray 101 includes a base 102 which defines an impression table 105 which extends between an inner periphery 104 and outer periphery 106.

An outer wall 108 extends upwardly from outer periphery 106 of base 102. An inner wall 110 extends upwardly from inner periphery 104 of base 102.

A handle 112 is connected to the base 102 at a handle end 114 wherein the base 102 the outer wall 108 and the inner wall 110 are dimensioned and configured to be placed around a jaw.

The impression table 105 includes numerus knockout panels 120 which can be selectively removed from the impression table 105 thereby providing an opening 122 through the impression table 105.

I claim:

1. A dental impression tray, which is configured to receive impression material and a set of teeth thereon for operably taking impressions of the teeth, the dental impression tray includes;
a) a U shaped base which includes a planar impression table connected to upwardly projecting outer and inner walls, the outer wall extending along an outer periphery, and an inner wall extending along an inner periphery;
b) the impression table together with the inner and outer walls together define a bite channel;
c) the impression table includes numerous planar knock-out panels arranged in side by side fashion along a center line of the impression table, the knock-out panels include frangible portions such that the knock out panels are configured to be selectively removable from the impression table thereby selectively providing an opening through the impression table.

2. The dental impression tray claimed in claim 1 wherein each knock out panel includes a panel gap at each open side, thereby separating the knock out panels, wherein the gap extends transversely relative to the center line between the inner and outer wall.

3. The dental impression tray claimed in claim 2 wherein each knock out panel includes an inner frangible tab at a tab end adjacent the inner wall, and an outer frangible tab at the other tab end adjacent the outer wall, the tabs removably connect each knock out panel to the impression table.

4. The dental impression tray claimed in claim 3 wherein each knock out panel includes a guide hole centered in the knock out panel, which provides a locatable landing adapted for receiving an instrument for selectively applying force to the knockout panel to break the inner and outer frangible tabs thereby removing a selected knock out panel.

5. The dental impression tray claimed in claim 3 wherein each knock out panel includes a guide hole centered in the knock out panel, which provides a locatable landing adapted for receiving the end of a knock out pointer thereon for selectively applying force to break the inner and outer frangible tabs thereby removing a selected knock out panel.

6. The dental impression tray claimed in claim 3 wherein each knock out panel includes a guide hole centered in the knock out panel, the guide hole configured for receiving a rigid rod there through, such that twisting rod and thereby the knock out panel, breaks the inner and outer frangible tabs and thereby selectively removes the knock out panel creating the opening in the impression table.

7. The dental impression tray claimed in claim 2 further includes an end cross brace connecting the inner and outer walls at each distal end of the U shaped planar impression table to increase the stiffness of the dental impression tray.

8. The dental impression tray claimed in claim 1 wherein the impression tray is configured for taking impressions of a set of lower mandibular teeth.

9. The dental impression tray claimed in claim 1 wherein the inner wall forms a continuous arch shaped palate guard such that the impression tray is adapted for more comfortable use for taking impressions of a set of upper maxillary teeth.

10. The dental impression tray claimed in claim 1 wherein the outer wall includes outer slits for receiving there through excess impression material upon taking an impression.

11. The dental impression tray claimed in claim 1 wherein the inner wall includes inner slits for receiving there through excess impression material upon taking an impression.

12. The dental impression tray claimed in claim 1 further including a handle connected to the base at a handle end, the handle for hand gripping and manipulating the dental impression tray.
